(19) United States
(12) Patent Application Publication
(10) Pub. No.: US 2018/0358781 A1
(43) Pub. Date: Dec. 13, 2018

(54) SURGE PROTECTIVE DEVICE

(71) Applicant: MITSUBISHI MATERIALS CORPORATION, Tokyo (JP)

(72) Inventors: Yoshitaka Mayuzumi, Naka-shi (JP); Shinji Sakai, Naka-shi (JP); Ryoichi Sugimoto, Naka-shi (JP)

(21) Appl. No.: 15/775,129

(22) PCT Filed: Oct. 26, 2016
(86) PCT No.: PCT/JP2016/004705

§ 371 Date: May 10, 2018

(30) Foreign Application Priority Data
Dec. 8, 2015 (JP) 2015-239103

(51) Int. Cl. H01T 4/12; H05F 3/04

(52) U.S. Cl. CPC H01T 4/12; H05F 3/04

(57) ABSTRACT

To provide a surge protective device that can suppress the sublimation and disappearance of a discharge-assisting part and can improve the durability thereof. The surge protective device comprises an insulating tube, a pair of sealing electrodes for closing openings on the both ends of the insulating tube so as to seal a discharge control gas inside the tube, and a discharge-assisting part formed on the inner circumferential surface of the insulating tube, wherein the pair of sealing electrodes have a pair of convex electrode portions projecting inwardly and facing to each other, and the discharge-assisting part is composed of a laminate of an insulating layers made of an insulating material and ion-source layers made of an ion-source material that are formed on the top and bottom surfaces of the insulating layer.

### BACKGROUND OF THE INVENTION

### Field of the Invention

The present invention relates to a surge protective device for protecting a wide variety of equipment from surges caused by a lightning strike or the like so as to prevent accidents.

### Description of the Related Art

The connecting parts of telephones, facsimile machines, and electronic devices for communication equipment such as a modem to communication lines, and power lines, antenna, as well as image display driving circuits for CRTs, liquid crystal display TVs, plasma display TVs, and the like are vulnerable to electric shocks such as abnormal voltage (surge voltage) due to a lightning surge or an electrostatic surge. To these parts are installed surge protective devices in order to prevent electronic devices and the printed circuit boards equipped therewith from being broken down due to thermal damage, ignition, or the like caused by abnormal voltage.

As a conventional technology, Patent document 1, for example, discloses an arrester (surge protective device) which includes a pair of convex electrode portions projecting from a pair of sealing electrodes and facing to each other, and an insulating tube on the inner surface of which a discharge-assisting part is formed. Typically in such a surge protective device, a discharge-assisting part made of a carbon material is formed on the inner surface of the insulating tube so as to face to the intermediate area between the pair of convex electrode portions. Such a discharge-assisting part is made of a conductive ion-source material such as graphite or the like and acts as an ion source for promoting the initial discharge.

### PRIOR ART DOCUMENT

### Patent Document

[Patent Document 1] Japanese Utility Model Registration No. 3151069

### SUMMARY OF THE INVENTION

### Problems to be Solved by the Invention

The following problems still remain in the conventional technologies described above.

In the conventional configuration, thermal and expansion energies that are produced between the pair of convex electrode portions during an arc discharge may disadvantageously cause a portion of the discharge-assisting part to sublimate and disappear, which can result in unstable (increased) discharge voltage during repeated discharges.

In particular, the sublimation and disappearance of the discharge-assisting part tend to prominently occur in the case of a large current discharge. In addition, when a discharge current significantly exceeds the warranty coverage, not only the change of the electrode design but also the increase in its size or the parallel connection thereof may be required for the stable operation.

One possible way to suppress the sublimation and disappearance of the discharge-assisting part may be to increase the thickness of the discharge-assisting part. However, since the discharge-assisting part can disappear from the close contact surface with the insulating tube during a discharge, the satisfactory suppression cannot be obtained.

The present invention has been made in view of the aforementioned circumstances, and an object of the present invention is to provide a surge protective device that can suppress operation destabilization due to the sublimation and disappearance of the discharge-assisting part.

### Means for Solving the Problems

The present invention adopts the following configurations in order to overcome the aforementioned problems. Specifically, a surge protective device according to a first aspect of the present invention comprises: an insulating tube; a pair of sealing electrodes for closing openings on the both ends of the insulating tube so as to seal a discharge control gas inside the tube; and a discharge-assisting part formed on the inner circumferential surface of the insulating tube, wherein the pair of sealing electrodes have a pair of convex electrode portions projecting inwardly and facing to each other, and the discharge-assisting part is composed of a laminate of an insulating layer(s) made of an insulating material and of ion-source layers made of an ion-source material that are formed on the top and bottom surfaces of the insulating layer.

In the surge protective device according to the first aspect of the present invention, the discharge-assisting part is composed of a laminate of an insulating layer(s) made of an insulating material and of ion-source layers made of an ion-source material that are formed on the top and bottom surfaces of the insulating layer. Therefore, if the ion-source layer exposed on the surface sublimates and disappears due to discharge, the underlying insulating layer can sublimate and disappear at the same time together with the ion-source layer exposed on the surface so as to expose the next ion-source layer, which can allow the discharge assisting function to be maintained.

A surge protective device according to a second aspect of the present invention is characterized by the surge protective device according to the first aspect, wherein the discharge-assisting part has at least two or more of the insulating layers and three or more of the ion-source layers such that the ion-source layers and the insulating layers are alternately laminated.

Specifically, in this surge protective device, since the discharge-assisting part has at least two or more of the insulating layers and three or more of the ion-source layers such that the ion-source layers and the insulating layers are alternately laminated, the ion-source layers can be exposed on the surface repeatedly at least three times or more as they sublimate and disappear. As a result, the operation can be stable during repeated discharges.

A surge protective device according to a third aspect of the present invention is characterized by the surge protective device according to the first or second aspect wherein the insulating layer(s) is/are made of silicon oxide.

Specifically, in this surge protective device, since the insulating layer(s) is/are made of silicon oxide, the layer(s) can readily sublimate and disappear due to thermal energy that is produced during an arc discharge so as to expose the next ion-source layer.

A surge protective device according to a fourth aspect of the present invention is characterized by the surge protective device according to any one of the first to third aspects, wherein a plurality of the discharge-assisting parts are formed in a circumferential direction of the inner circumferential surface of the insulating tube, and at least one of the plurality of discharge-assisting parts has the insulating layer set to have a different thickness from the others.

Specifically, in this surge protective device, since at least one of the plurality of discharge-assisting parts formed in a circumferential direction of the inner circumferential surface of the insulating tube has the insulating layer set to have a different thickness from the others, if one of the discharge-assisting parts having the insulating layer of a given thickness disappears due to discharge arc energy, another discharge-assisting part having the insulating layer of other thickness can still remain, which can allow the discharge assisting function to be maintained.

### Effects of the Invention

According to the present invention, the following effects may be provided.

Specifically, since the surge protective device according to the present invention comprises discharge-assisting part(s) composed of a laminate of an insulating layer(s) made of an insulating material and of ion-source layers made of an ion-source material that are formed on the top and bottom surfaces of the insulating layer; if the ion-source layer exposed on the surface sublimates and disappears due to discharge, the underlying insulating layer can sublimate and disappear at the same time together with the ion-source layer exposed on the surface so as to expose the next ion-source layer, which can allow the discharge assisting function to be maintained.

Therefore, even when the size of a surge current or the number of discharges increases, the performance of the surge protective device can be excellently maintained. In particular, the surge protective device according to the present invention is suitable for the power source and communication equipment for infrastructure (railroad-related or regenerated energy-related (e.g., solar cell, wind power generation, and the like)) where the tolerance to a large current surge is required.

### BRIEF DESCRIPTION OF THE DRAWINGS

FIG. 1 is an enlarged cross-sectional view of the essential part of a surge protective device according to a first embodiment of the present invention.

FIG. 2 is an axial cross-sectional view of a surge protective device according to the first embodiment.

FIG. 3 is a perspective cut-away view of the essential part of a surge protective device according to a second embodiment of the present invention, showing a part of an insulating tube.

FIG. 4 is an enlarged cross-sectional view of the essential part of a surge protective device according to the second embodiment, showing each discharge-assisting part.

### DESCRIPTION OF THE EMBODIMENTS

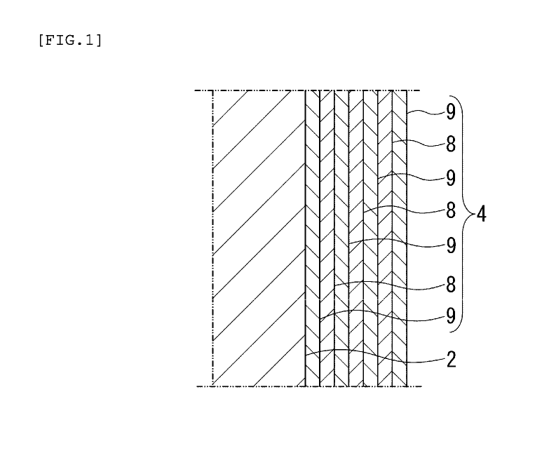

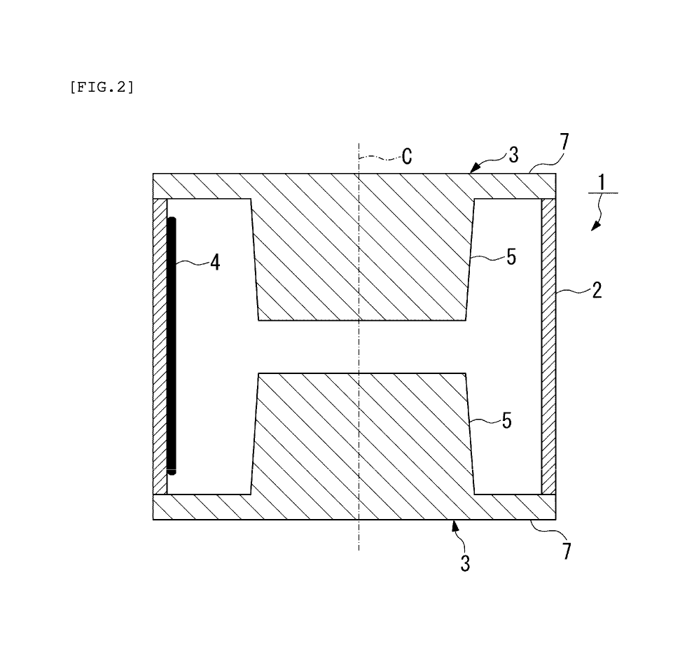

Hereinafter, a surge protective device according to a first embodiment of the present invention will be described with reference to FIGS. 1 and 2. In the drawings referenced in the following description, the scale of each component may be changed as appropriate so that each component is recognizable or is readily recognized.

As shown in FIGS. 1 and 2, a surge protective device 1 according to the present embodiment includes an insulating tube 2, a pair of sealing electrodes 3 for closing the openings on the both ends of the insulating tube 2 so as to seal a discharge control gas inside the tube, and a discharge-assisting part 4 formed on the inner circumferential surface of the insulating tube 2.

The pair of sealing electrodes 3 have a pair of convex electrode portions 5 projecting inwardly and facing to each other.

The discharge-assisting part 4 is composed of a laminate of insulating layers 8 made of an insulating material and ion-source layers 9 made of an ion-source material that are formed on the top and bottom surfaces of the insulating layers 8.

Furthermore, the discharge-assisting part 4 has at least two or more of the insulating layers 8 and three or more of the ion-source layers 9 such that the ion-source layers 9 and the insulating layers 8 alternately laminated. Specifically, the discharge-assisting part 4 has a structure in which the layers are repeatedly laminated on the inner circumferential surface of the insulating tube 2 so that ion-source layer 9 is formed on the insulating layers 8, which is then formed on the ion-source layer 9, and so forth, and the bottommost layer that is on the side of the insulating tube 2 and the topmost layer that is the innermost surface are the ion-source layers 9. Note that, in the present embodiment, the discharge-assisting part 4 is configured as a laminate of the ion-source layers 9 of four layers and the insulating layers 8 of three layers.

The discharge-assisting part 4 is linearly formed on the inner circumferential surface of the insulating tube 2 along the axis C of the convex electrode portions 5.

The ion-source layers 9 are the constituents of the discharge-assisting part made of a conductive material, for example, a carbon material.

The insulating layers 8 are made of the same material as the insulating tube 2 or a material contained therein. For example, when the insulating tube 2 is made of a crystalline ceramic material such as alumina containing silicon oxide such as SiO₂, the insulating layers 8 are made of a ceramic material containing silicon oxide (silica) such as SiO₂.

For the insulating layers 8, other insulating materials including ceramic materials such as magnesia, zirconia, and the like can also be employed. In addition, although the insulating layers 8 are formed so as to cover the ion-source layers 9, they may be formed so as to have a larger area than that of the ion-source layers 9 with a part of the insulating layers 8 being formed directly on the inner circumferential surface of the insulating tube 2.

The ion-source layers 9 and the insulating layers 8 can be laminated as follows. For example, a raw powder material and an organic binder for the insulating layers 8 are mixed into a slurry. Next, the slurry is used to make a green sheet using a roll coater for forming a thin sheet. Then, the green sheet is cut into pieces, which is coated with graphite that can be an ion source. Next, the green sheet pieces are laminated so as to sandwich the graphite to produce a laminate. Then, when the insulating tube 2 is fired, the laminate is adhered to the inside of the insulating tube 2 and fired with the insulating tube 2 to produce a laminate of the ion-source layers 9 and the insulating layers 8.

For example, the thickness of the single ion-source layer 9 is set to be 10 μm, and the thickness of the single insulating layer 8 is set to be 100 μm.

The sealing electrodes 3 are composed of, for example, 42-alloy (Fe: 58 wt %, Ni: 42 wt %), Cu, or the like.

Each of the sealing electrodes 3 has a discoidal flange 7 fixed to each of the openings on the both ends of the insulating tube 2 with a conductive fusion material (not shown) in a close contact state by a heat treatment. Inside the flange 7, the convex electrode portion 5 in a columnar shape is integrally formed with the flange 7, which projects inwardly and has a smaller outer diameter than the inner diameter of the insulating tube 2.

The insulating tube 2 is made of a crystalline ceramic material such as alumina. However, the insulating tube 2 may be a tube made of a glass such as a lead glass.

The conductive fusion material described above is, for example, a brazing material containing Ag, e.g., an Ag—Cu brazing material.

The discharge control gas sealed inside the insulating tube 2 as described above is an inert gas or the like, such as, for example, He, Ar, Ne, Xe, Kr, SF₆,CO₂, C₃F₈, C₂F₆, CF₄, H₂, air, etc., and a combination of these gases.

When an overvoltage or overcurrent enters the surge protective device 1, firstly the initial discharge occurs between the discharge-assisting part 4 and the convex electrode portions 5, which triggers further progress of discharge, and then a discharge occurs between a pair of the flanges 7 or between the convex electrode portions 5.

As described above, in the surge protective device 1 according to the present embodiment, the discharge-assisting part 4 is composed of the laminate of the insulating layers 8 made of the insulating material and the ion-source layers 9 made of an ion-source material that are formed on the top and bottom surfaces of the insulating layers 8. Therefore, if the ion-source layer 9 exposed on the surface sublimates and disappears due to discharge, the underlying insulating layer 8 can sublimate and disappear at the same time together with the ion-source layer 9 exposed on the surface so as to expose the next ion-source layer, which can allow the discharge assisting function to be maintained.

In addition, since the discharge-assisting part 4 has at least two or more of the insulating layers 8 and three or more of the ion-source layers 9 such that the ion-source layers 9 and the insulating layers 8 are alternately laminated, the ion-source layers 9 can be exposed on the surface repeatedly at least three times or more as they sublimate and disappear. As a result, the operation can be stable during repeated discharges.

Furthermore, since the insulating layers 8 are made of silicon oxide, the layer can readily sublimate and disappear due to thermal energy that is produced during an arc discharge so as to readily expose the next ion-source layer.

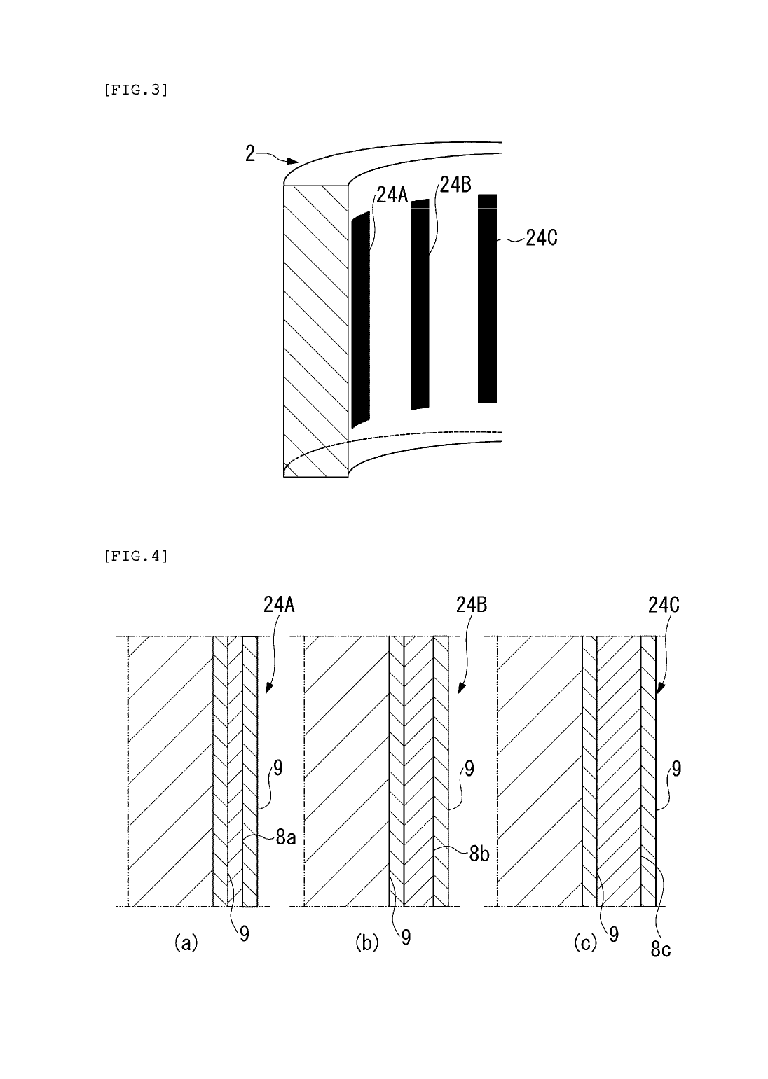

Next, a surge protective device according to a second embodiment of the present invention will be described below with reference to FIGS. 3 and 4. Note that, in the following description of the second embodiment, the same components as those in the first embodiment described above are denoted by the same reference numerals, and thus the description thereof is omitted.

The second embodiment is different from the first embodiment in the following points. In the first embodiment, the single discharge-assisting part 4 is formed on the inner circumferential surface of the insulating tube 2, whereas in a surge protective device according to the second embodiment as shown in FIGS. 3 and 4, a plurality of discharge-assisting parts 24A, 24B, and 24C are formed on the inner circumferential surface of the insulating tube 2 at intervals from each other in a circumferential direction.

In addition, in the second embodiment, at least one of the plurality of discharge-assisting parts 24A, 24B, and 24C has the insulating layer set to have a different thickness from the others.

Specifically, in the second embodiment, the thickness of the insulating layer 8b of the discharge-assisting part 24B is larger than that of the insulating layer 8a of the discharge-assisting part 24A, and the thickness of the insulating layer 8c of the discharge-assisting part 24C is larger than that of the insulating layer 8b of the discharge-assisting part 24B.

For example, the thickness of the insulating layer 8a of the discharge-assisting part 24A is set to be 100 μm, the thickness of the insulating layer 8b of the discharge-assisting part 24B is set to be 150 μm, and the thickness of the insulating layer 8c of the discharge-assisting part 24C is set to be 200 μm.

As described above, in the surge protective device according to the second embodiment, since at least one of the plurality of discharge-assisting parts 24A, 24B, and 24C formed in a circumferential direction of the inner circumferential surface of the insulating tube 2 has the insulating layer set to have a different thickness from the others, one of the discharge-assisting parts having the insulating layer of a given thickness (for example, discharge-assisting part 24A) disappears due to discharge arc energy, other discharge-assisting part(s) having the insulating layer of other thickness (for example, discharge-assisting part 24B and/or 24C) can still remain, which can allow the discharge assisting function to be maintained.

The technical scope of the present invention is not limited to the aforementioned embodiments, but the present invention may be modified in various ways without departing from the scope or teaching of the present invention.

For example, although the discharge-assisting part 4 is linearly formed in each embodiment described above, it may be formed in a dotted-line-like, a plurality of dot-like configuration, or the like, or alternatively the plurality of discharge-assisting parts 4 may be formed in the combination of those configurations.

### REFERENCE NUMERALS

1: surge protective device, 2: insulating tube, 3: sealing electrode, 4, 24A, 24B, 24C: discharge-assisting part, 5: convex electrode portion, 8, 8a, 8b, 8c: insulating layer, 9: ion-source layer, C: axis of insulating tube

What is claimed is:

1. A surge protective device comprising:
an insulating tube;
a pair of sealing electrodes for closing openings on the both ends of the insulating tube so as to seal a discharge control gas inside the tube; and
a discharge-assisting part formed on the inner circumferential surface of the insulating tube, wherein
the pair of sealing electrodes have a pair of convex electrode portions projecting inwardly and facing to each other, and
the discharge-assisting part is composed of a laminate of an insulating layer(s) made of an insulating material and of ion-source layers made of an ion-source material that are formed on the top and bottom surfaces of the insulating layer.

2. The surge protective device according to claim 1, wherein the discharge-assisting part has at least two or more of the insulating layers and three or more of the ion-source layers such that the ion-source layers and the insulating layers are alternately laminated.

3. The surge protective device according to claim 1, wherein the insulating layer is made of silicon oxide.

4. The surge protective device according to claim 1, wherein
a plurality of discharge-assisting parts are formed in a circumferential direction of the inner circumferential surface of the insulating tube, and
at least one of the plurality of discharge-assisting parts has the insulating layer set to have a different thickness from the others.
